(19) United States
(12) Patent Application Publication
(10) Pub. No.: US 2005/0130527 A1
(43) Pub. Date: Jun. 16, 2005

(54) UV stabilized fibrous articles and method of making the same

(75) Inventors: John M. Sebastian, Maplewood, MN (US); Stefan H. Gryska, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/732,991

(22) Filed: Dec. 11, 2003

(51) Int. Cl. B32B 15/04

(52) U.S. Cl. 442/149; 428/343; 428/354

(57) ABSTRACT

A stabilized fibrous article has fabric in contact with an adhesive layer containing one or more ultraviolet light stabilizers.

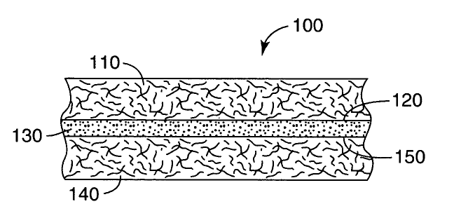

### BACKGROUND

Achieving long-term ultraviolet light (i.e., UV) stability of fabrics is a problem for many indoor and outdoor applications such as, for example, banners, signs, wall coverings, geotextiles, and automotive and marine interior fabrics.

One approach to achieving long-term UV stability of fabrics is to add UV stabilizer to individual fibers during the fiber synthesis. However, the amount of UV stabilizer that can be directly incorporated into a fiber may be limited, for example, by one or more of the fiber composition, fiber thickness, solubility in the fiber material, and compatibility with the fiber material. Also, incorporation of large quantities of UV stabilizers into fibers may cause physical weakening of the fibers, and in some cases UV stabilizer(s) do not survive the processing conditions used to make the fiber. For example, UV light stabilizers may not survive the elevated temperatures typically used in the production of meltblown nonwoven fabrics.

Another approach to achieving stability of fabrics is to apply UV light stabilizer as a substantially uniform fiber coating (e.g., by saturation coating or spraying) to the fibers or the fabric. However, the relatively large amount of UV stabilizer on the fiber surface needed to achieve long term UV stability may result in changes to properties such as, for example, surface energy and adhesion of subsequent coatings (e.g., inks).

### SUMMARY

In one aspect, the present invention provides a stabilized fibrous article comprising a first fabric having a major surface and a pressure sensitive adhesive layer in contact with the major surface, wherein the pressure sensitive adhesive comprises from at least 20 percent by weight up to and including 40 percent by weight of at least one ultraviolet light stabilizer, based on the total weight of the adhesive.

In one embodiment, the stabilized fibrous article further comprises a substrate having a major surface in contact with the adhesive layer.

In another aspect, the present invention provides a method of making a stabilized fibrous article comprising contacting a pressure sensitive adhesive with a major surface of a first fabric, wherein the adhesive comprises from greater than 20 percent by weight up to and including 40 percent by weight of at least one ultraviolet light stabilizer based on the total weight of the adhesive.

UV stabilized fibrous articles according to the present invention are typically suitable for use in a variety of applications including, for example, those applications in which exposure to direct sunlight is likely. In addition, methods of the present invention are applicable to a wide range of fiber and fabric types.

As used herein,
the term “ultraviolet light stabilizer” includes UV absorbers and hindered amine light stabilizers (HALS);
“pressure sensitive adhesive” means an adhesive that is aggressively and permanently tacky at room temperature and firmly adheres to a variety of dissimilar surfaces upon mere contact without the need of more than finger or hand pressure, and has a sufficiently cohesive holding and elastic nature so that they can be handled with the fingers and removed from smooth surfaces without leaving a residue; and
“fabric” means a plurality of interconnected fibers having two opposed major surfaces. The term “fabric” does not include films or microporous membranes.

### BRIEF DESCRIPTION OF THE DRAWING

The drawing is an exemplary cross-sectional side view of a stabilized nonwoven article according to the present invention.

### DETAILED DESCRIPTION

Referring now to the drawing, exemplary stabilized fibrous article 100 comprises fabric 110 having major surface 120. Pressure sensitive adhesive layer 130 contacts major surface 120, and optionally contacts major surface 150 of substrate 140. Pressure sensitive adhesive layer 130 comprises at least one pressure sensitive adhesive and at least 20 weight percent, on a total weight basis of the pressure sensitive adhesive layer, of at least one UV stabilizer such as, for example, a UV absorber, a hindered amine light stabilizer, or a combination thereof. In some embodiments of the present invention, substrate 140 may be, for example, a release liner or a fabric.

Without wishing to be bound by theory, it is believed that UV stabilizer in the adhesive layer gradually migrates from the pressure sensitive adhesive layer into the fabric. During UV exposure, UV stabilizer that has diffused to the fabric fibers is typically depleted. By providing a gradual release of UV stabilizer, the fabric fibers achieve a relatively continuous supply of UV stabilizer.

Useful fabrics include woven, knitted, and nonwoven fabrics. Suitable woven and knitted fabrics include, for example, those formed from threads or yarns of synthetic or natural materials including cotton, linen, rayon, polyamide, polyester, polyolefin, polyurethane, and combinations thereof. Suitable nonwoven fabrics include, for example, carded, air laid, spunlaced, spunbonded, and meltblown fabrics. For example, the nonwoven fabric may comprise a plurality of continuous synthetic fibers. Nonwoven fabrics may be lofty and open (e.g., having an internal void volume of at least 75, 80, or 85 percent up to and including 95 percent or even more) or may be partially consolidated, for example, by needletacking and/or embossing. Suitable nonwoven fabrics include, for example, those formed from fibers or threads of synthetic or natural materials including cotton, linen, rayon, acrylics, polyamides, polyesters, polyolefins, cellulosic esters, polyurethanes, and combinations thereof. The fabric may have a graphic image thereon, for example, by printing (e.g., ink jet printing or screen printing) or dyeing.

The fabric may have any thickness, but typically, the thickness is in a range of from at least 10, 25, or 1000 micrometers up to and including 0.5, 2.5, or even 5 millimeters or more.

The pressure sensitive adhesive layer comprises at least one material that has pressure sensitive adhesive properties. For example, the pressure sensitive adhesive can be a single pressure sensitive adhesive or the pressure sensitive adhesive can be a combination of two or more pressure sensitive adhesives. Useful pressure sensitive adhesives include, for example, solvent-based pressure sensitive adhesives, 100 percent solids pressure sensitive adhesives, latex-based pressure sensitive adhesives, hot melt pressure sensitive adhesives, microsphere pressure sensitive adhesives, and combinations thereof.

Suitable pressure sensitive adhesives include, for example, those based on natural rubbers, synthetic rubbers, styrene block copolymers, polyvinyl ethers, poly (meth)acrylates (including both acrylates and methacrylates), polyolefins, and silicones. The pressure sensitive adhesive may comprise an inherently tacky material, or if desired, tackifiers may be added to a tacky or non-tacky base material to form the pressure sensitive adhesive. Useful tackifiers include, for example, rosin ester resins, aromatic hydrocarbon resins, aliphatic hydrocarbon resins, and terpene resins. Other materials can be added for special purposes, including, for example, plasticizers, hydrogenated butyl rubber, glass beads, conductive particles, filler, dyes, pigments, and combinations thereof.

Pressure sensitive adhesives are commercially available from a number of sources including, for example, 3M Company, Saint Paul, Minn. Further examples of useful pressure sensitive adhesives include those generally described in U.S. Pat. No. 4,112,213 (Waldman); U.S. Pat. No. 4,917,928 (Heinecke); U.S. Pat. No. 4,917,929 (Heinecke); U.S. Pat. No. 5,141,790 (Calhoun); U.S. Pat. No. 5,045,386 (Stan et al.); U.S. Pat. No. 5,229,207 (Paquette et al.); U.S. Pat. No. 5,296,277 (Wilson et al.); U.S. Pat. No. 5,670,557 (Dietz et al.); and U.S. Pat. No. 6,232,366 (Wang et al.); the disclosures of which as incorporated herein by reference.

The pressure sensitive adhesive layer may have any thickness. For example, the pressure sensitive adhesive layer may have a thickness in a range of from at least 25, 100, or 250 micrometers up to and including 500, 1000, or 2500 micrometers or even more.

Depending on the specific fabric chosen and intended application, the pressure sensitive adhesive layer may be selected such that, it cannot be mechanically separated from the fabric without damaging the fabric. This may be desirable, for example, in the case that two fabrics are bonded together by the pressure sensitive adhesive layer.

The pressure sensitive adhesive layer may be continuous, for example, as a continuous adhesive film or a continuous or coating on fibers at one major surface of the fabric. Alternatively, the pressure sensitive adhesive layer can be a discontinuous layer. In one embodiment, the pressure sensitive adhesive layer may have the shape of an alphanumeric character or graphic image. Suitable methods for applying the pressure sensitive adhesive layer include, for example, roll coating, gravure coating, curtain coating, spray coating, screen printing, with the method typically chosen based on the type of coating desired.

The optional substrate may be any solid material, and may have any shape. Suitable substrate materials include, for example, ceramics (e.g., tile, masonry), glass (e.g., windows), metal, cardboard, fabrics, and polymer films (e.g., coated or uncoated polymer films). More specifically, the substrate may be, for example, a motor vehicle, building, window, billboard, boat, wall, floor, door, or a combination thereof.

In one embodiment, the substrate may be a release liner, for example, to protect the adhesive before usage. Examples of release liners include silicone coated kraft paper, silicone coated polyethylene coated paper, silicone coated or non-coated polymeric materials such as polyethylene or polypropylene, as well as the aforementioned base materials coated with polymeric release agents such as silicone urea, urethanes, and long chain alkyl acrylates, such as generally described in U.S. Pat. No. 3,997,702 (Schurb et al.); U.S. Pat. No. 4,313,988 (Koshar et al.); U.S. Pat. No. 4,614,667 (Larson et al.); U.S. Pat. No. 5,202,190 (Kantner et al.); and U.S. Pat. No. 5,290,615 (Tushaus et al.); the disclosures of which are incorporated by reference herein. Suitable commercially available release liners include those available under the trade designation “POLYSLIK” from Rexam Release of Oakbrook, Ill., and under the trade designation “EXHERE” from P.H. Glatfelter Company of Spring Grove, Pa.

In another embodiment, the substrate may be a fabric which may be the same as, or different from, the first fabric. In this embodiment, the fibrous article may be a multilayer fabric having little or no tackiness on exterior surfaces. The resultant stabilized fibrous article may be thus used, for example, for any use known for fabrics, but will typically have prolonged UV stability compared to the component fabrics from which it is made. For example, a stabilized meltblown fabric may be prepared by bonding two layers of meltblown fabric with pressure sensitive adhesive comprising at least 20 percent by weight of at least one UV stabilizer.

Suitable UV stabilizers include ultraviolet light absorbers (UV absorbers) and hindered amine light stabilizers (HALS). While the UV stabilizer may comprise one or more UV absorbers without any HALS composition or vice versa, typically, the UV absorber(s) and HALS composition are both included in the pressure sensitive adhesive layer. For example, the ratio of HALS to UV absorber, on a weight basis, may be in a range of from at least 1:1, 2:1, or 3:1 up to 4:1, 5:1, 6:1, or even higher.

Suitable UV absorbers for incorporation into the pressure sensitive adhesive layer include those compounds which function by absorbing UV radiation and converting it a non-damaging form of energy such as, for example, heat. UV absorbers are well known and widely available from commercial sources including, for example, Mayzo, Inc., Norcross, Ga.; Ciba Specialty Chemicals Corp., Tarrytown, N.Y.; and Clariant Corp., Charlotte, N.C.

Examples of UV absorbers include benzophenone and its derivatives such as, for example, 2,2′-dihydroxybenzophenone, 2,2′,4,4′-tetrahydroxybenzophenone, 2,2′-dihydroxy-4,4′-dimethoxybenzophenone, 2-hydroxy-4-n-octoxybenzophenone, 2,2′-dihydroxy-4,4′-diethoxybenzophenone, 2,2′-dihydroxy-4-methoxy-4′-ethoxybenzophenone, 2-hydroxy-4,4′-5′-trimethoxybenzophenone, 2-hydroxy-4-propoxy-4′,6′-dibromobenzophenone, 2-hydroxy-4-ethoxy-4′-bromobenzophenone); benzotriazole and its derivatives such as for example, 2-(2′-hydroxy-5′-methylphenyl)benzotriazole, 2-(2′-hydroxy-5′-tert-butylphenyl)benzotriazole, 2-(2′-hydroxy-3 ′-methyl-5 ′-tert-butylphenyl)benzotriazole, 2-(2′-hydroxy-3′,5′-dimethylphenyl)benzotriazole, 2-(2-hydroxy-5-tert-octylphenyl) benzotriazole, 2-(2H-benzotriazole-2-yl)-4-methylphenyl, 2-(2′-hydroxy-3′,5 ′-di-tert-amylphenyl)benzotriazole, α-[3-[3-(2H-benzotriazol-2-yl)-5-(1,1-dimethylethyl)-4-hydroxyphenyl]-1-oxopropyl]-ω-hydroxypoly(oxo-1,2-ethanediyl), α-[3-[3-(2H-benzotriazol-2-yl)-5-(1,1-dimethylethyl)-4-hydroxyphenyl]-1-oxopropyl]-ω-[3-[3-(2H-benzotriazol-2-yl)-5-(1,1-dimethylethyl)-4-hydroxyphenyl]-1-oxopropoxy]poly(oxy-1,2-ethanediyl), and 2-(2′-hydroxy-3′-di-tert-butylphenyl)benzotriazole; benzoate esters, phenyl salicylates, derivatives of crotonic acid (e.g., alpha-beta-methyl-beta-(p-methoxyphenyl)crotonic acid methyl ester and alpha-cyano-beta-N-(2-methyl-indolinyl)crotonic acid methyl ester), malonic acid esters, cyanoacrylates; and combinations thereof.

Hindered amine light stabilizer (“HALS”) compositions are well known in the art and include, for example, derivatives of tetramethylpiperidine (e.g., substituted hydroxytetramethylpiperidines, including the polycondensation product of hydroxypiperidines with a suitable acid or with a triazine), and those that can be considered polymeric tertiary amines. Broadly, these include high molecular weight (i.e., above about 500), oligomeric, and polymeric compounds that contain a polyalkylpiperidine constituent, including polyesters, polyethers, polyamides, polyamines, polyurethanes, polyureas, polyaminotriazines and copolymers thereof. Further details concerning hindered amine light stabilizers and their preparation may be found, for example, in U.S. Pat. No. 5,015,682 (Galbo); U.S. Pat. No. 4,895,901 (Ramey et al.); and U.S. Pat. No. 4,895,901 (Karrer), the disclosures of which are incorporated herein by reference.

Many HALS compositions are available commercially, for example, under the trade designations “TINUVIN 152”, “TINUVIN 622”, “TINUVIN 770”, “TINUVIN 123”, “TINUVIN 292”, “TINUVIN 144”, “TINUVIN 765”, or “CHIMASSORB 119”, from Ciba Specialty Chemicals Corporation, Tarrytown, N.Y.

UV stabilizer is incorporated into the pressure sensitive adhesive layer in an amount of from greater than 20 or 25 percent by weight up to and including 30, 35, or even 40 percent by weight, based on the total weight of the pressure sensitive adhesive layer, provided the pressure sensitive properties are maintained. At levels of UV stabilizer above 40 percent by weight, pressure sensitive adhesive properties are typically substantially degraded, while at levels below 20 percent by weight of UV stabilizer are typically insufficient to achieve long term UV stabilization.

To facilitate incorporation into the adhesive and/or the diffusion rate of the UV stabilizer(s), at least one component (e.g., all) of the UV stabilizer may be selected such that it is liquid at or near room temperature and/or or soluble in the adhesive mixture.

UV stabilizer is typically mixed or thoroughly blended with the pressure sensitive adhesive prior to applying the adhesive to the fabric and/or substrate. The mixing or blending of the ultraviolet radiation screener with the adhesive material may be accomplished, for example, by first dissolving the adhesive material in a solvent, such as an organic solvent or water, and then mixing the UV stabilizer into this solution. The solution containing the UV stabilizer is then coated onto the fabric and/or the substrate by any of the previously described methods, and the solvent is evaporated thus forming a layer of adhesive having UV stabilizer dissolved and/or dispersed therein.

Stabilized fibrous articles of the present invention are useful in a wide variety of applications including, for example, mats, vehicle interiors, protective coverings, wall coverings, upholstery, graphic arts display materials (especially outdoor display materials such as signs and billboards and banners), and geotextiles.

Objects and advantages of this invention are further illustrated by the following non-limiting examples, but the particular materials and amounts thereof recited in these examples, as well as other conditions and, details, should not be construed to unduly limit this invention.

### EXAMPLES

Unless otherwise noted, all reagents used in the examples were obtained, or are available, from general chemical suppliers such as Sigma-Aldrich Corp., Saint Louis, Mo., or may be synthesized by known methods.

Accelerated Weathering Test

The aluminum plates with affixed fabric samples are placed in an accelerated weathering testing device (obtained under the trade designation “MODEL CI65A WEATHER-O-METER” from Atlas Electric Devices Company, Chicago, Ill.) with testing performed according to American Society for Testing of Materials (ASTM) G155, Cycle 1 (daylight filter, irradiance of 0.35 W/m²/nm, ultraviolet light wavelength of 340 nm with 102 minutes of light at 63° C. black panel temperature and 18 minutes light and water spray).

During accelerated weathering testing, the fabric samples are examined periodically for signs of degradation, such as fiber shedding, cracking, and color change. The time at which one or more signs of degradation are first observed is reported as the maximum stability limit.

The following abbreviations are used throughout the examples:

“Fabric A” refers to a spunlaced nonwoven fabric having a basis weight of 55 grams/square meter (g/m²) and a thickness of 0.30 millimeters (mm), prepared by hydroentangling an air laid web of 1.5 denier×3.8 centimeters long polypropylene staple fibers obtained under the trade designation “HERCULON OLEFIN FIBER” from FiberVisions, Inc., Covington, Ga. A conventional hydraulic entangling system consisting of 6 manifolds/jets (3 above and 3 below) was used. The basic operating procedure is described in U.S. Pat. No. 5,389,202 (Everhart et al.), the disclosure of which is incorporated herein by reference. Each manifold had an orifice diameter of 120 microns. Orifices were positioned in a single row at spacing of about 16 orifices per linear centimeter of manifold. Manifold water pressure was successively ramped up to 127 kg/cm², which generated high-energy fine columnar water jets. The air laid web was passed under the manifolds at a line speed of about 10 m/min, and then dried.

“Fabric B” refers to a multicomponent fiber web having a basis weight of 100 g/m² and a thickness of 0.30 mm prepared by melt blown fiber production techniques according generally to the procedure of Backing Sample 16 in U.S. Pat. No. 6,107,219 (Joseph), the disclosure of which is incorporated herein by reference. The multicomponent fibers had a hot melt adhesive component (20 percent by weight) and a polyurethane component (80 percent by weight).

“Fabric C” refers to a meltblown polyethylene fabric having a basis weight of 86 g/m² and a thickness of 0.20 mm, obtained under the trade designation “TYPE TM07-27-98-02” from TransWeb, LLC, Vineland, N.J.

“Fabric D” refers to a spunbonded nylon fabric (basis weight=65 g/m², thickness=0.15 millimeters) that was obtained under the trade designation “CEREX G066380” from Western Nonwovens, Inc., Carson, Calif.

“Fabric E” refers to a spunlaced nonwoven fabric prepared by hydroentangling an air-laid web consisting of 47.5 percent by weight of rayon fibers (1.5 denier×3.8 cm long, trade designation “TYPE B649”, obtained from Lenzing Fiber Corporation, Lowland, Tenn.), 47.5 of polyester staple fibers (2.0 denier×3.8 cm long, trade designation “TYPE T224”, obtained from KoSa B.V., Houston, Tex.), and 5 weight percent of PET/coPET sheath/core bicomponent fibers (2.0 denier×3.8 cm long, trade designation “CELBOND TYPE T254”, obtained from KoSa B.V.) generally according to the procedure used to prepare Fabric A, except that prior to hydroentangling, the carded web was first passed through an oven to melt the sheath component of the bicomponent fibers thereby providing a somewhat cohesive air-laid web. The nonwoven fabric had a basis weight of 57 g/m² and a thickness of 0.25 mm.

“Film F” refers to Fabric A that had been hot pressed under 2.5 metric tons of force and a temperature of 170° C. for 15 minutes to convert it completely into a film 0.06 mm thick.

“ADH1” refers to a water-based latex adhesive prepared generally according to the procedure described in WO 01/81491 A1 (Loncar), Examples 6 and 7, by blending: 42.7 parts by weight of a dispersion of hollow tacky microspheres prepared as generally described in WO 92/13924 (Steelman, et al.), Example 1; 48.8 parts of an acrylate pressure-sensitive adhesive commercially available from 3M Company under the trade designation “FASTBOND 49”; 0.9 part by weight of an acrylic resin solution available from Rohm & Haas Company, Philadelphia, Pa., under the trade designation “ACRYSOL ASE-60”; 2.5 parts by weight of n-octanol; 5 parts by weight of a mixture of 58 parts of water, 3 parts of lithium hydroxide monohydrate, and 39 parts of ammonium hydroxide; and 0.1 part by weight of a defoamer available under the trade designation “FOAMASTER JMY” from Cognis Corp., Ambler, Pa.;

“LS1 ” refers to a hindered amine light stabilizer believed to be bis (1-octyloxy-2,2,6,6-tetramethyl-4-piperidyl) sebacate and obtained under the trade designation “TINUVIN 123” from Ciba Specialty Chemicals Corporation.

“LS2” refers to a UV absorber obtained under the trade designation “TINUVIN 1130” from Ciba Specialty Chemicals Corporation, and believed to be a mixture of 50 parts by weight of α-[3-[3-(2H-benzotriazol-2-yl)-5-(1,1-dimethylethyl)-4-hydroxyphenyl]-1-oxopropyl]-~hydroxypoly(oxo-1,2-ethanediyl), 38 parts by weight of α-[3-[3-(2H-benzotriazol-2-yl)-5-(1,1-dimethylethyl)-4-hydroxyphenyl]-1-oxopropyl]-ω-[3-[3-(2H-benzotriazol-2-yl)-5-(1,1-dimethylethyl)-4-hydroxyphenyl]-1-oxopropoxy]poly(oxy-1,2-ethanediyl), and 12 parts by weight of polyethyleneglycol 300.

### Examples 1-5 and Comparative Examples A-H

ADH1 acrylic latex adhesive was combined with a quantity of UV absorber and/or HALS composition as indicated in Table 1 and coated onto a polyester release liner and dried resulting in a film having a dry thickness of 0.06 mm. The dry film was then adhered to the film or fabric as indicated in Table 1, and then the polyester film was peeled off and the pressure sensitive adhesive layer was affixed to an aluminum test panel. Next, the assembly was subjected to the Accelerated Weathering Test.

TABLE 1

| | | | Amount of UV | |
|---|---|---|---|---|
| | | | Stabilizer in | Maximum |
| | | UV | Adhesive, | Stability |
| Example | Fabric/Film | Stabilizer | percent by weight | Limit (hr) |
| Comparative | A | none | 0 | 150 |
| Example A | | | | |
| Comparative | A | LS1 | 7.8 | 290 |
| Example B | | LS2 | 4.4 | |
| Comparative | B | none | 0 | 150 |
| Example C | | | | |
| Comparative | C | none | 0 | 715 |
| Example D | | | | |
| Comparative | D | none | 0 | 245 |
| Example E | | | | |
| Comparative | E | none | 0 | 150 |
| Example F | | | | |
| Comparative | F | none | 0 | 150 |
| Example G | | | | |
| Comparative | F | LS1 | 7.8 | >690 |
| Example H | | LS2 | 4.4 | |
| Example 1 | A | LS1 | 24.6 | 500 |
| | | LS2 | 4.0 | |
| Example 2 | B | LS1 | 19.6 | >360 |
| | | LS2 | 11.3 | |
| Example 3 | C | LS1 | 19.6 | >755 |
| | | LS2 | 11.3 | |
| Example 4 | D | LS1 | 19.6 | 500 |
| | | LS2 | 11.3 | |
| Example 5 | E | LS1 | 21.5 | 191 |
| | | LS2 | 4.0 | |

Various unforeseeable modifications and alterations of this invention may be made by those skilled in the art without departing from the scope and spirit of this invention, and it should be understood that this invention is not to be unduly limited to the illustrative embodiments set forth herein.

1. A stabilized fibrous article comprising a first fabric having a major surface and a pressure sensitive adhesive layer in contact with the major surface, wherein the pressure sensitive adhesive comprises from at least 20 percent by weight up to and including 40 percent by weight of at least one ultraviolet light stabilizer, based on the total weight of the adhesive.

2. The stabilized fibrous article of claim 1, wherein the fabric comprises a woven or knitted fabric.

3. The stabilized fibrous article of claim 1, wherein the fabric comprises a nonwoven fabric.

4. The stabilized fibrous article of claim 3, wherein the nonwoven fabric is selected from the group consisting of meltblown fabrics, spunbonded fabrics, spunlaced fabrics, needletacked fabrics, and combinations thereof.

5. The stabilized fibrous article of claim 3, wherein the nonwoven fabric comprises a plurality of continuous synthetic fibers.

6. The stabilized fibrous article of claim 3, wherein the nonwoven fabric comprises a lofty open nonwoven fabric.

7. The stabilized fibrous article of claim 1, wherein the adhesive comprises more than one pressure-sensitive adhesive material.

8. The stabilized fibrous article of claim 1, wherein the ultraviolet light stabilizer comprises at least one ultraviolet light absorber.

9. The stabilized fibrous article of claim 8, wherein the adhesive comprises greater than 20 percent by weight of at least one ultraviolet light absorber, based on the total weight of the pressure sensitive adhesive.

10. The stabilized fibrous article of claim 1, wherein the ultraviolet light stabilizer comprises at least one hindered amine light stabilizer.

11. The stabilized fibrous article of claim 8, wherein the adhesive comprises from greater than 20 percent up to and including 30 percent by weight of at least one hindered amine light stabilizer, based on the total weight of the adhesive.

12. The stabilized fibrous article of claim 1, wherein the ultraviolet light stabilizer comprises at least one ultraviolet light absorber and at least one hindered amine light stabilizer.

13. The stabilized fibrous article of claim 12, wherein the adhesive comprises from greater than 20 percent up to and including 30 percent by weight of at least one ultraviolet light stabilizer, based on the total weight of the adhesive.

14. The stabilized fibrous article of claim 1, wherein the pressure sensitive adhesive layer further contacts a major surface of a substrate.

15. The stabilized fibrous article of claim 14, wherein the substrate comprises a release liner.

16. The stabilized fibrous article of claim 14, wherein the substrate comprises a nonwoven fabric.

17. The stabilized fibrous article of claim 16, wherein the nonwoven fabric is selected from the group consisting of meltblown fabrics, spunbonded fabrics, spunlaced fabrics, needletacked fabrics, and combinations thereof.

18. The stabilized fibrous article of claim 16, wherein the nonwoven fabric comprises a plurality of continuous synthetic fibers.

19. The stabilized fibrous article of claim 16, wherein the nonwoven fabric comprises a lofty open nonwoven fabric.

20. The stabilized fibrous article of claim 14, wherein the pressure sensitive adhesive layer comprises more than one pressure-sensitive adhesive material.

21. The stabilized fibrous article of claim 14, wherein the ultraviolet light stabilizer comprises at least one ultraviolet light absorber.

22. The stabilized fibrous article of claim 14, wherein the adhesive comprises greater than 20 percent by weight of at least one ultraviolet light absorber, based on the total weight of the adhesive.

23. The stabilized fibrous article of claim 14, wherein the ultraviolet light stabilizer comprises at least one hindered amnine light stabilizer.

24. The stabilized fibrous article of claim 14, wherein the adhesive comprises from greater than 20 percent up to and including 30 percent by weight of at least one hindered amine light stabilizer, based on the total weight of the adhesive.

25. The stabilized fibrous article of claim 14, wherein the ultraviolet light stabilizer comprises at least one ultraviolet light absorber and at least one hindered amine light stabilizer.

26. The stabilized fibrous article of claim 14, wherein the pressure sensitive adhesive layer comprises from greater than 20 percent up to and including 30 percent by weight of at least one ultraviolet light stabilizer, based on the total weight of the adhesive.

27. A method of making a stabilized fibrous article comprising contacting a pressure sensitive adhesive with a major surface of a first fabric, wherein the adhesive comprises greater than 20 percent by weight of at least one ultraviolet light stabilizer based on the total weight of the adhesive.

28. The method of claim 27, further comprising contacting the pressure sensitive adhesive with a substrate.
